(19) United States
(12) Patent Application Publication
(10) Pub. No.: US 2009/0108828 A1
(43) Pub. Date: Apr. 30, 2009

(54) ADAPTIVE POWER SUPPLY

(76) Inventor: Rajesh Edamula, Sunnyvale, CA (US)

Correspondence Address: Haynes and Boone, LLP;IP Section, 2323 Victory Avenue, SUITE 700, Dallas, TX, 75219, US

(21) Appl. No.: 11/931,933

(22) Filed: Oct. 31, 2007

(51) Int. Cl. H02J 1/00

(52) U.S. Cl. 323/318

(57) ABSTRACT

In one embodiment, an apparatus includes a power negotiator configured to receive a power request signal, determine if the request signal is acceptable, and transmit a signal based on the determination. The request signal comprises a requested power level. A switcher coupled to the power negotiator generates the requested power level if the request signal is acceptable.

### TECHNICAL FIELD

The present disclosure relates generally to power supplies.

### BACKGROUND

The demand for handheld and/or mobile devices is ever increasing. Such handheld and/or mobile devices are varied in physical structure, operational characteristics, and intended application. Many of these devices require some level of DC power to operate. These devices may use an internal battery for some or all of their power requirements, but invariably provide an interface for connection with an external DC source that may function to charge the device's internal battery and/or power the device for use during continued connection to the DC source.

In this regard, the DC source, typically an AC/DC converter or adapter, receives an AC source at an input to the adaptor and provides at its output a well-regulated DC voltage for use in the device. However, each load device may require a different DC power level (voltage and/or current) to drive or power-up the device's internal circuitry/components. As such, there are many different kinds of interface connectors mating or connecting with many different kinds of AC adapters. Even devices that have substantially the same power requirements may use a different interface configuration.

### BRIEF DESCRIPTION OF THE DRAWINGS

FIG. 1 is a block diagram showing an example embodiment of an adaptive DC power outlet including connectivity between a power unit, a source (“SC”) device, and a sink (“SK”) device.

FIG. 2 is a block diagram of the source device and the sink device of FIG. 1 including a source power negotiator (“PNSC”) and a sink power negotiator (“PNSK”) configured to communicate with each other, according to one embodiment.

FIG. 3 is a graph showing an example of asynchronous modulation of a message that may be used in communicating between the devices in FIG. 2.

FIG. 4 is a graph showing an example of the timing of various events, and the general relationship of power levels and message communication/traffic between the “SC” device and the “SK” device.

FIG. 5 shows an example of a communication adaptation sequence between the “PNSC” and the “PNSK” that negotiates a power level to be output from the “SC” to the FIG. 6 shows another example of a communication adaptation sequence between the “PNSC” and the “PNSK” that negotiates a power level to be output from the “SC” to the “SK”.

FIG. 7 is a flowchart showing an example of an adaptation sequence relative to the “PNSK”.

FIG. 8 is a flowchart showing an example of an adaptation sequence relative to the “PNSC”.

### DESCRIPTION OF EXAMPLE EMBODIMENTS

### Overview

In one embodiment, an apparatus includes a power negotiator configured to receive a power request signal, determine if the request signal is acceptable, and transmit a signal based on the determination. The request signal comprises a requested power level. A switcher, coupled to the power negotiator, generates the requested power level if the request signal is acceptable.

In another embodiment, an apparatus includes a power switcher having an input for receiving a power level, and a sink negotiator configured to send a request signal for the power level and to receive a signal determining the acceptability of the request signal. Acceptance of the request signal resulting in the power level being received for input into the power switcher is determined by feedback loop adaptation sequence communication.

In still another embodiment, a system includes a source device having a source negotiator configured to receive a power request signal, determine if the request signal is acceptable, and transmit a signal based on the determination. The request signal comprises a requested power level. A source switcher, coupled to the source negotiator, generates the requested power level if the request is acceptable. The system further includes a sink device having a sink negotiator configured to send the power request signal to the source negotiator, and a sink switcher having an input for receiving the power level. Acceptance of the request signal resulting in the power level being received for input into the sink switcher is determined by feedback loop adaptation sequence communication.

### Description of Example Embodiments

Particular embodiments will now be described with references to the accompanying figures, wherein like reference numerals refer to like elements throughout. The terminology used in the description presented herein in not intended to be interpreted in any limited or restrictive manner, simply because it is being utilized in conjunction with a detailed description of certain embodiments of the invention. Furthermore, various embodiments of the invention (whether or not specifically described herein) may include novel features, no single one of which is solely responsible for its desirable attributes or which is essential to practicing the subject matter herein described.

The term “sink”, periodically referenced herein and in the figures as “SK”, is a broad term intending to include handheld, mobile, or similar type load devices typically used for business or personal use, that require, utilize, receive, or draw power from an external DC source. Such handheld or mobile items are extremely varied in physical structure, operational characteristics, and intended application and may include a laptop computer, cell phone, PDA, monitoring device, personal grooming apparatus, and hardware tool, to name just a few.

The term “source”, periodically referenced herein and in the figures as “SC”, is a broad term intending to include, among other components, a device such as a converter or power adapter that provides DC power at its output for utilization by the “sink” device. Such sources may include devices that receive an AC voltage as an input to the source, convert the received AC to DC, and then provide that DC as an output from the source. Alternatively, the source may be a stand-alone device that generates and provides a DC output without receiving an input, AC or otherwise.

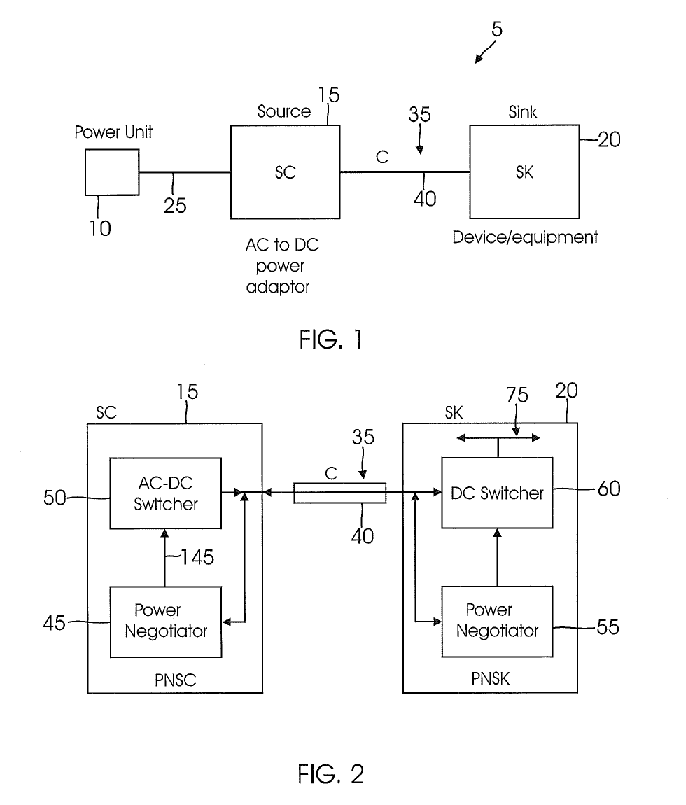

FIG. 1 is a block diagram showing an example embodiment of an adaptive DC power outlet system 5. Connectivity in the system 5 is shown between a “power unit” 10, a “source” device (SC) 15, and a “sink” device (SK) 20. Voltage from the “power unit” 10, typically in the form of 110-120 vac, is supplied to the source device 15 by a cord 25 or similar type cable hardwired to the source device 15. Once received by the source device 15, the VAC is converted to some DC voltage by any number of rectification and regulation processes well-known in the art.

In the particular embodiment shown in FIG. 1, the source device 15 and the sink device 20 are configured to communicate with each other. A communication link 35 between the source device 15 and the sink device 20 facilitates information or data messaging and power level communication or traffic, i.e., the transmission and reception of such information or power levels, between the source device 15 and the sink device 20. Means for providing such communication between the source device 15 and the sink device 20 may be provided by any two-conductor shielded cable 40, periodically referenced herein and in the drawings as “C”. In addition, persons of ordinary skill in the art will understand that a variety of cable technologies and/or associated port configurations may be utilized to provide the communication link 35 between the source device 15 and the sink device 20.

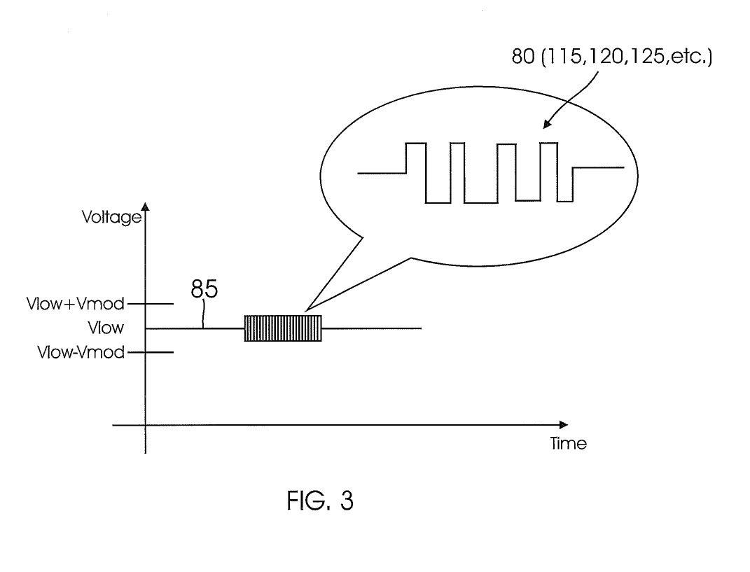

FIG. 2 is a block diagram of the source device 15 and the sink device 20 in FIG. 1 according to one example embodiment. The source device 15 includes a power negotiator 45, designated as “PNSC”, and an AC-DC switcher 50 (power adaptor). Similarly, the sink device 20 includes a power negotiator 55, designated as “PNSK”, and a DC switcher 60 (power switcher). The communication link 35 between the source device 15 and sink device 20 permits data messaging between the two power negotiators 45, 55 to determine a power level output from the source device 15 to the sink device 20.

After the source device 15 and the sink device 20 are connected, the sink device 20 transmits a request for power to the source device 15, which can be wireless or through communication link 35. The source device 15 then determines whether the request was proper, e.g., within its power supply capabilities and/or correct request format. If the request was proper, an acknowledgment is sent to the sink device 20. If the sink device 20 properly receives the acknowledgment and is ready to receive power, the sink device 20 sends a confirmation signal to the source device 15. Upon receipt of the confirmation signal, the source device 15 builds up the requested level of power in the AC-DC switcher 50. Power build-up is conventional and known to those skilled in the art. In this regard, the source AC-DC switcher 50 functions as a variable or adjustable output regulator or adaptor whose power output is controlled by the source negotiator 45.

Once the requested power level is reached, as determined by the power negotiator 45, the power is provided to the sink device 20. When the power negotiator 55 in the sink device 20 determines that the proper power level is available, the DC switcher 60 routes or otherwise transmits power to components in need of the power. The sink power negotiator 55 is coupled to the DC switcher 60 and detects when the power at the DC switcher 60 is at the requested level. Upon such detection, the sink power negotiator 55 triggers a switch (not shown) that enables the power to be distributed to various circuitry/components of the sink device 20 through an output terminal 75 of the DC switcher 60. In this regard, the DC switcher 60 may include circuitry to perform other power related tasks such as converting the received power levels to another value or form for distribution to the various circuitry/components of the sink device 20.

Before power is provided as described above, the source device 15 and sink device 20 are first connected to communicate with each other. For example, by default, a low voltage (typically 3-4 vdc) with a low power (current) limit is provided from the source device 15 to the sink device 20 along the cable 40. The low voltage is generally used to power up, initialize, and build a request or data message in the power negotiator 55 of a sink device 20 that does not have an internal power source. However, even in those sink devices that do have an internal power source, the low voltage from the source device 15 may be used alone or in combination with the internal power source to supply start-up power to the power negotiator 55.

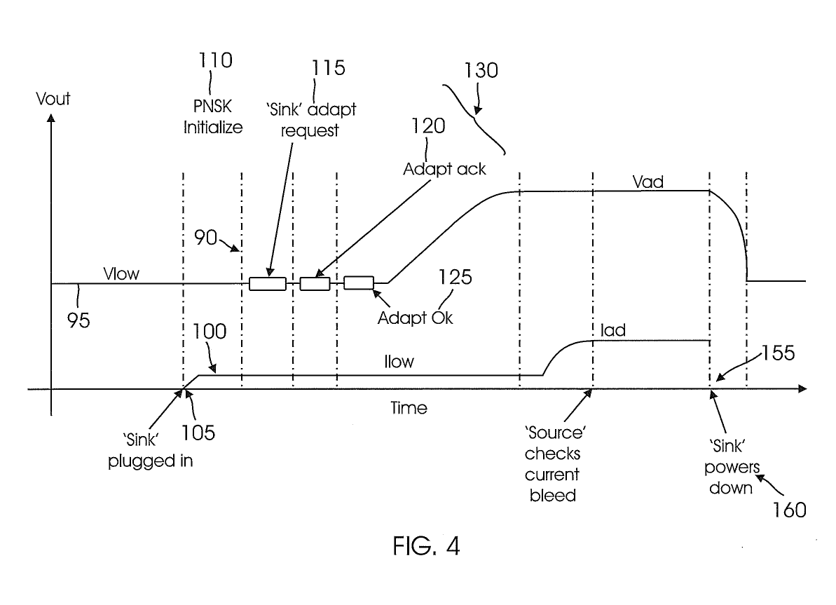

FIG. 3 is a graph showing one example of information modulation of a signal at a low dc voltage 85 as a function of time. The initial low dc level Vlow is a reference or carrier voltage level 85 for the modulation of various data messages 80, described herein, at ±Vmod along the cable 40 interconnecting the source device 15 and the sink device 20. The data messages 80 may attempt to negotiate, through communication between the source device and the sink device (also referred to as feedback loop adaptation sequence discussion and compromise, as will be discussed in detail below), a determination or an agreement between the source device 15 and any given sink device on a proper power level output (DC voltage and current) from the source device 15 for charging/powering the sink device 20.

Communication of the data message 80 may be accomplished and controlled through use of an UART (Universal Asynchronous Receiver/Transmitter). However, persons of ordinary skill in the art will understand that although the particular embodiment is described herein as using an UART control chip and a two-conductor shielded cable 40 to facilitate message communication/traffic between the source device 15 and the sink device 20, many other control devices (USART, for example) and interconnect or interface technologies may also be suitable.

In addition, persons of ordinary skill in the art will understand that the data message 80 may be communicated wirelessly between the source device 15 and the sink device 20, for example, using RF (Radio Frequency) technology, or infrared signaling schemes, to name a few. In these wireless scenarios, as described above, the wireless adaptation sequence will usually commence when the sink device 20 detects that is it connected (hardwired) to the source device 15. The source device 15 would then qualify received messages by detecting connectivity to the sink device 20 through a measure of the current drawn at the output of the source device 15.

When decoding messages, both the source power negotiator 45 and the sink power negotiator 55 should use the same rate, although the speed or data rate (bps) is not critical. For the UART based digital message protocol, a character (byte) based protocol may be used for simplicity. In one particular embodiment, as described below, a message data stream may include eight (8) data bits, an odd parity bit for error detection, and a single stop bit.

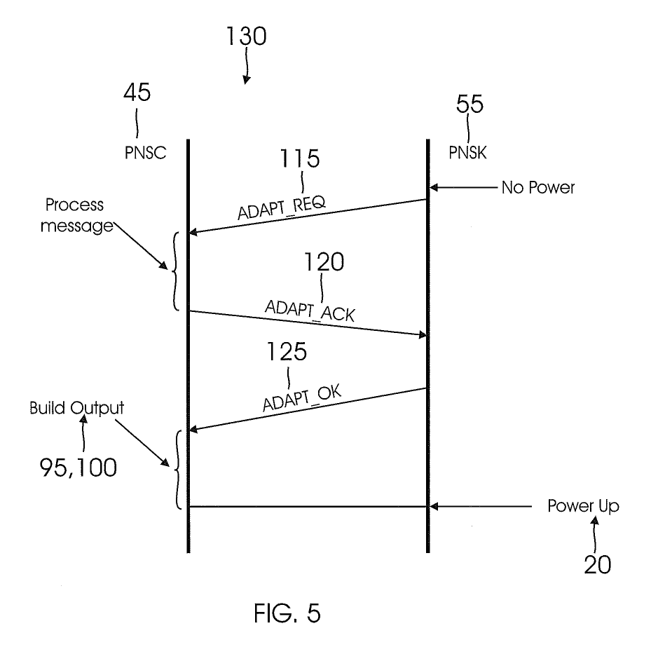

FIG. 4 shows the timing of various events and the relationship of power levels (voltage 95 and current 100) and message communication/traffic between the sink device 15 and the source device 20 according to one example embodiment. Various nomenclature in FIG. 4 include:
Vlow: Output low voltage that is always present to initialize or power-up the power adaptation circuits on the sink device 20;
Vad: Voltage generated and supplied by the source device 15 to the sink device 20 in the steady state as per the request from the “PNSK” 55;
Ilow: Current drawn by the sink device 20 when plugged or connected to the source device 15; and
Iad: Current drawn by the sink device 20 when powered-on.

Voltage levels 95 are plotted graphically, increasing from zero volts at the origin to some positive value along a vertical axis, and time is shown increasing from zero at the origin to some time later along a horizontal axis. In this regard, the indication of an exact voltage level is not critical as the voltage level 95 may vary according to the requirements of the sink device 20 making the request for power from the source device 15. Likewise, the exact time, whether measured in seconds, minutes, hours, etc., is not critical, so long as the concept that certain events occur in an order relative to each other is understood.

For example, as shown in FIG. 4, the sink device 20 is first plugged-in or connected to the source device 20 at time 105 to start an initializing period 110 of the sink device. The voltage level 95 or time it takes the sink device to initialize may vary depending on a number of factors, including the initialization power requirements and sequence of the sink device. After initialization, a request or adaptation request (“ADAPT_REQ”) 115 for power is transmitted from the sink device to the source device. An acknowledgment or adaptation acknowledgment (“ADAPT_ACK”) 120 is then transmitted from the source device back to the sink device. Next, a confirmation or adaptation okay (“ADAPT_OK”) message 125 is sent from the sink device back to the source device. Upon receipt, the voltage level 95 is built up in the source device to the requested level.

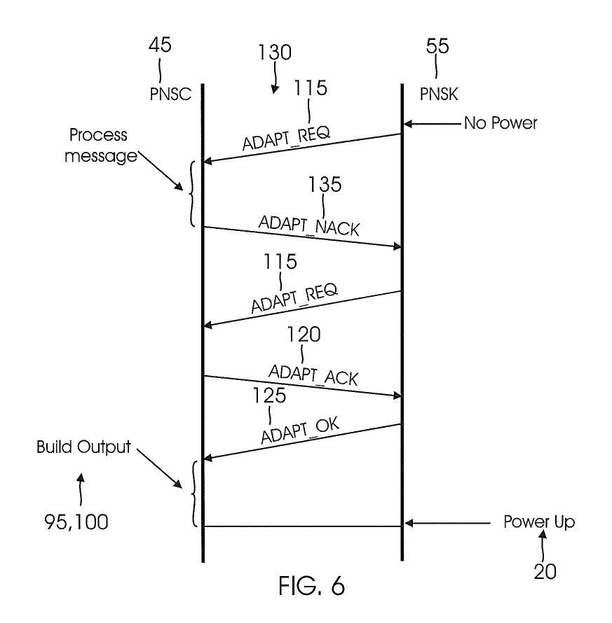

FIG. 5 shows an example of a communication adaptation sequence 130 between the source power negotiator 45 and the sink power negotiator 55 that negotiates a power level to be output from the source device 15 to the sink device 20, where the flow is from top to bottom. In this example embodiment, after initialization of the sink device 15, the request 115 is communicated from the sink power negotiator 55 to the source power negotiator 45. The request is decoded or processed by the source power negotiator 45. If there were no errors in transmission and the request is within the power level output range available and capable of being supplied from the source device 15 to the sink device 20, the acknowledgment 120 is transmitted from the source power negotiator 45 to the sink power negotiator 55 indicating acceptance of the request 115. The confirmation message 125 is then communicated from the sink power negotiator 55 to the source power negotiator 45, which allows the AC-DC switcher of the source device 15 to build the power level to the requested voltage value and current limit thresholds set by the request 115 for output to the sink device 20.

FIG. 6 shows another example of a communication adaptation sequence 130 between the source power negotiator 45 and the sink power negotiator 55 that negotiates a power level to be output from the source device 15 to the sink device 20. In this example, the request 115 from the sink device is not accepted or acknowledged by the source. If one or more errors occurred in the data transmission and/or the request 115 from the sink device 20 was not within the working limits of the source device 15, an error message or adaptation not acknowledged (“ADAPT_NACK”) 135, indicating non-acceptance of the request 115, is generated from the source power negotiator 45 back to the sink power negotiator 55.

In the event that the request 115 was deemed invalid, the sink power negotiator 55 can stop requesting (shut down) and indicate the error, for example, by a visual or audible indicator on the sink device 20, to the user. Alternatively, as further shown in FIG. 6, the sink power negotiator 55 can automatically communicate another request 115 to the source power negotiator. For example, in the case that an error occurred due to data loss, the sink power negotiator 55 may send the same data message as previously sent. In the case where an error indication occurred because the sink power negotiator 55 requested power that was not within the output range of the source device 15, a different request 115 may be sent by the sink power negotiator 55 requesting or selecting a different power level output, typically lower, be supplied from the source device 15. If the new request is deemed valid by the sink power negotiator 45, the source device will eventually generate a power output to the level requested by the sink power negotiator 55, as previously described.

In this regard, the back-and-forth message communication, e.g., a single or multiple requests and acknowledgements to supply and receive power, constitutes a feedback loop adaptation or negotiation sequence 130 between the source power negotiator 45 and the sink power negotiator 55 that is used to determine the proper DC voltage and current limits for charging/powering a given sink device 20.

Regardless of which feedback loop adaptation or negotiation sequence is prescribed, in one example embodiment, many of the message communication/traffic occurs prior to the build-up of power in the source device 20 to ensure that the voltage regulators of the source device function properly.

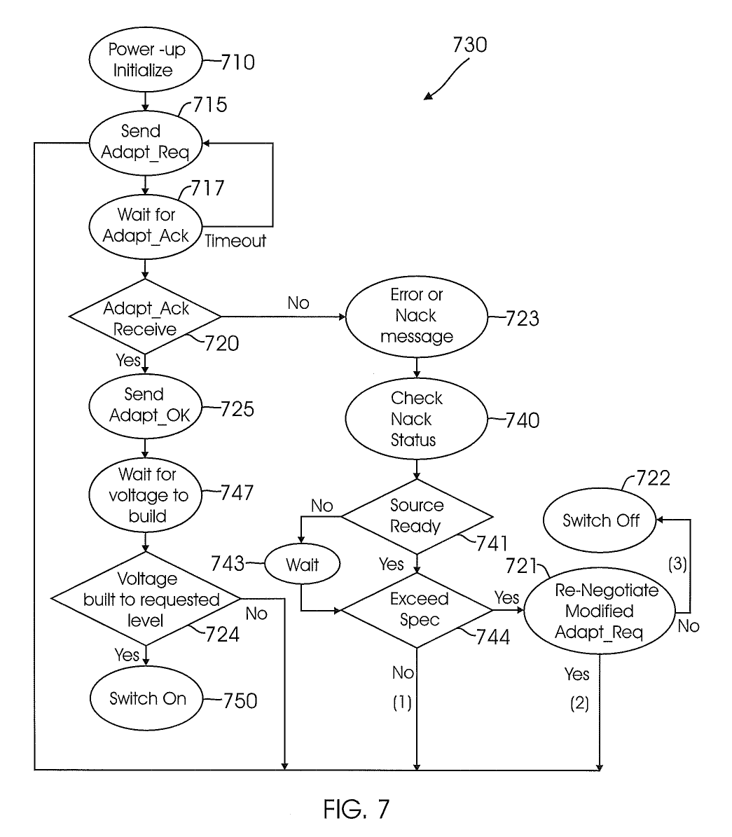

FIG. 7 is a flowchart showing an example embodiment of an adaptation sequence 730 relative to the sink device. After an initialization 710 of the sink device, a request for power 715, indicating desired power levels, is sent from the sink device to the source device. The sink device then waits for a predetermined amount of time for an acknowledgment 717 from the source device for a predetermined amount of time. The time period can be any suitable duration for system requirements, such as less than a second to a minute or more. If there is no acknowledgment received within the designated time period, the sink device may time out, and then sends another request 715. No acknowledgment may indicate that the request was never received or that the source device was unable to transmit a response.

Alternatively, if the acknowledgment was not received, as determined at 720, and an error message or NACK was received 723 prior to timing out, the sink device may (1) re-transmit the request 715 if the request is within the power output specification 744 of the sink device, (2) re-negotiate 721 the desired power levels if the previous request exceeded the output power specification 744 of the sink device, or (3) switch off 722 if it cannot re-negotiate, as determined at 721.

In regard to option (1) as indicated above, after an error message or NACK is received 723, NACK status is checked 740 to determine if the source device is ready 741 to accept another request from the sink device. If the source device is not ready to accept another request from the sink, the sink will wait 743 a predetermined amount of time before attempting re-transmission of the previous request 715 where the request is within the power output specification 744 of the sink device and the data was corrupted during the previous request transmission. The time period can be any suitable duration for system requirements, such as less than a second to a minute or more.

On the other hand, if the source device is ready to accept another request from the sink and the request is within the power output specification 744 of the sink device, the sink will re-transmit the previous request 715.

In regard to option (2) as indicated above, the flowchart sequence proceeds as in option (1) described above, unless the previous request exceeded the power output specification as determined at 744. In this case, if the sink device can re-negotiate 721, it sends a modified request at 715, where the request may be for a lower power level from the source device.

However, as indicated by option (3) above, if the previous request exceeded the power output specification as determined at 744 and the sink device is unable to re-negotiate 721 the desired power levels, the sink device will switch/turn off, as indicated at 722.

Returning now to 720, if the acknowledgment is received by the sink device, it transmits a confirmation 725 to the source device. The sink device then waits for the voltage to build up 747 to the requested level 724 in the DC switcher of the sink device, at which time the DC switcher is enabled or switched on 750 to permit distribution of the power from the DC switcher to appropriate circuitry/components of the sink device. However, if the voltage does not reach the requested level 724 within a set period of time, the device would re-transmit another request 715 to begin a new adaptation feedback loop. The period of time for waiting can be any suitable amount, depending on device and system requirements, such as how fast the source device can build up a power for the sink device.

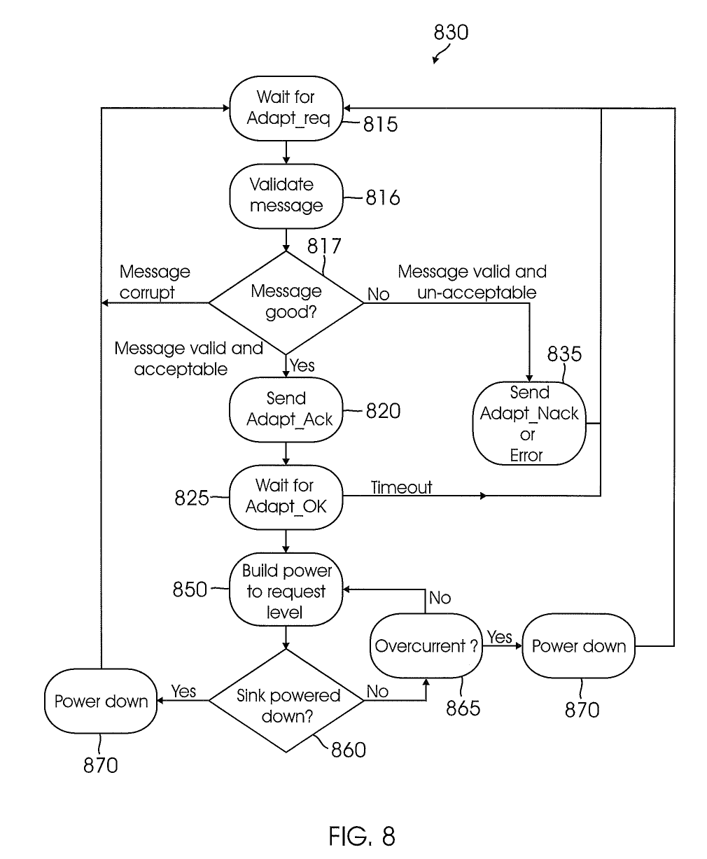

FIG. 8 is a flowchart showing an example embodiment of an adaptation sequence 830 relative to the source device 15. After initialization of the sink device, the source device waits for a request 815, indicating desired power levels, from the sink device. Once received, the request is validated 816 by the source device. If the request is found invalid, corrupt, or unacceptable at 817, an error or non-acknowledgment may be sent 835 to the sink device and the source device awaits another request for desired power levels from the sink device, as indicated at 815. If the request is corrupt and the source device is unable to send an error indication 835, the source device will simply wait for another request 815.

On the other hand, if the request or message is found good at 817, e.g., the sink request was within the output range of the source device, an acknowledgment is sent 820 to the sink device. The source device then waits for a confirmation 825 from the sink device. If confirmation of the acknowledgment is not received by the source device, due to, for example, a transmission error, the source device times out and returns to wait 815 for another request for desired power levels from the sink device. Alternatively, if confirmation 825 from the sink device is received by the source device, the source power negotiator permits the source switcher to build power to the requested level 850.

Once the source switcher has built power to the requested level, the source power negotiator may go into an idle state where it monitors and detects or senses current levels drawn by the sink device. A “low” current threshold condition caused by a sink device initiated by a power down 860 or unplugging the sink device from the source device causes the source device to power down 870. Another cause of a power down 870 by the source device may include a sink device initiated power down request message (not shown) from the sink device to the source device requesting the voltage be returned to the original or initial low voltage level. Such low current conditions cause the source device to power down 870 and wait 815 for a new message from the sink device. Current monitoring by the source device may further include detection of an over current condition 865 which may likewise cause the source device to power down 870 and wait 815 for another request from the sink device. If “low” current or over current levels are not detected or sensed by the source device, the source device continues to supply power at the requested level to the sink device.

Examples are shown below of messages and their associated formats (message parameters and message descriptions) in one example embodiment. Such message formats may include:

Adapt Request Message
REQ <Reserved><Voltage><Current>
REQ=One byte opcode for Adapt_Req message.
Reserved=One byte reserved for future definitions.
Voltage=Two byte value of output voltage in millivolts giving a range of approximately 65 volts.
Current=Two byte value of output current limit in milliamps giving a range of approximately 65 amps.
Total length of message=5 bytes.

Adapt Acknowledge Message
ACK <Reserved><Current><Voltage>
ACK=One byte opcode for Adapt_Ack message.
Reserved=One byte reserved for future definitions.
Voltage=Two byte value of output voltage in millivolts giving a range of approximately 65 volts.
Current=Two byte value of output current limit in milliamps giving a range of approximately 65 amps.
Total length of message=5 bytes.

Adapt No Acknowledge Message
NACK <Status>
NACK=One byte opcode for Adapt-Nack message.
Status=Two bytes for reporting type of error. Bits [15:0].
Bit [0]: Parity error detected on a previous request.
Bit [1]: If 1, source “SC” device not ready to accept Adapt Request.
Bit [2]: If 1, then voltage request exceeded limits, renegotiate if possible.
Bit [3]: If 1, then current request exceeded limits, renegotiate if possible.
Bit [4]: Reserved for future.
Total length of message=3 bytes.

### Adapt OK Message

OK
OK=One byte opcode for Adapt-OK message.
Total length of message=1 byte.

Persons of ordinary skill in the art will understand that other messages, for example, a power down message request “ADAPT_PDWN” or “ADAPT_VLOW” may be communicated back and forth between the source device 15 and the sink device 20.

Depending on various factors including, among others, material and manufacturing costs, intended application (professional and/or consumer), as well as, consumer expectation, to name a few, the devices described herein including the various cable configurations; the power unit, the source device, the sink device and their associated circuitry and housings may be constructed of any suitable material or combination of materials.

The adaptive power supply 5, as described herein, may be designed and incorporated into new handheld and/or mobile device, or be adapted for use in existing products as an after-market add-on. For example, the source device may be manually preconfigured or adjusted to meet the power requirements of a handheld and/or mobile device that does not include a sink negotiator capable of making a power output (voltage and current limit) request to the source device. In this case, the user would simply ensure device interface compatibility, connect the adaptive DC power outlet or source device to the pre-existing handheld or mobile device, and turn each of the units on. Power would then be supplied from the source device to the sink device to meet the sink device's power requirements for sustained operation.

Therefore, it should be understood that the invention can be practiced with modification and alteration within the sprit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. An apparatus comprising:
a power negotiator configured to receive a power request signal, determine if the request signal is acceptable, and transmit a signal based on the determination, wherein the request signal comprises a requested power level; and
a switcher coupled to the power negotiator, wherein the switcher generates the requested power level if the request signal is acceptable.

2. The apparatus of claim 1, wherein the power negotiator is configured to receive a plurality of different power request signals from a sink device and transmit an acceptable power level to the sink device.

3. The apparatus of claim 1, wherein the signal transmitted by the power negotiator comprises an acknowledgement or a non-acknowledgement of an acceptable request signal.

4. The apparatus of claim 3, wherein the power negotiator is further configured to receive a signal request different than the previously received signal request after transmission of the non-acknowledgement signal.

5. The apparatus of claim 1, wherein the requested signal is acceptable comprises a determination that the requested power level is within a power output range of the apparatus.

6. A method comprising:
receiving a request signal, the signal comprising a request for a power level;
determining if the request signal is acceptable;
transmitting a signal based on the determination; and
generating the requested power level if the request signal is acceptable.

7. The method of claim 6, further comprising providing the requested power level to a sink device.

8. The method of claim 6, further comprising receiving a plurality of request signals for different power levels from a sink device.

9. The method of claim 6, wherein the determining comprises determining whether the power level is acceptable for a source device.

10. The method of claim 6, wherein the transmitting comprises transmitting an acknowledging signal or a non-acknowledging signal of the acceptance of the requested signal.

11. The method of claim 10, further comprising receiving a signal request different that the previously received signal request after transmitting the non-acknowledging signal.

12. The method of claim 10, further comprising renegotiating a power level the requested power level is not acceptable.

13. The method of claim 12, wherein the renegotiating comprises a feedback loop adaptation signal communication.

14. The method of claim 13, wherein the feedback loop adaptation signal communication comprises:
receiving a plurality of power request signals, each power request signal comprising a different requested power level;
transmitting an acknowledgement signal indicating signal agreement of the power to be output in response to one of the power request signals being within a power output range; and
transmitting a non-acknowledgement signal in response to one of the power request signals not within the power output range and waiting for a power request signal of a different requested power.

15. The method of claim 14, further comprising determining a power down condition in response to one of a low current signal or an over current signal.

16. The method of claim 14, wherein the waiting is for a pre-determined amount of time.

17. An apparatus comprising:
a power switcher having an input for receiving a power level; and
a power negotiator configured to send a request signal for the power level and to receive a signal determining an acceptability of the request signal, wherein the determining comprises whether the power level is within a power range of a source device.

18. The apparatus of claim 17, wherein the power negotiator is further configured to transmit a request signal for different power levels if the requested power level is not accepted.

19. The apparatus of claim 18, wherein the requested power level is not accepted if the apparatus does not receive an acknowledgement or receives a negative acknowledgement or error signal.

20. A method comprising:
sending one of a plurality of signal requests, each of the signal requests corresponding to a request for a different power level; and
receiving a signal determining the acceptability of the signal request, wherein receiving the signal comprises receiving an acknowledging signal resulting in the power level being received or receiving a non-acknowledgment signal resulting in the sending of a different signal request.

21. The method of claim 20, further comprising sending a different signal request if a signal is not received within a pre-determined amount of time.

22. A system comprising:
a source device comprising:
a source power negotiator configured to receive a power request signal, determine if the request signal is acceptable, and transmit a first signal based on the determination, wherein the request signal comprises a requested power level; and
a source switcher coupled to the source power negotiator, wherein the switcher generates the requested power level if the request signal is acceptable;
a sink device comprising:
a sink power switcher having an input for receiving the requested power level from the source device; and
a sink power negotiator configured to send the power request signal to and to receive the first signal from the source device, wherein the determination comprises determining whether the power level is within a power range of the source device.

23. The system of claim 22, wherein the sink device is configured to transmit a request signal for different power levels if the requested power level is not accepted.

24. The system of claim 23, wherein the requested power level is not accepted if the sink device does not receive an acknowledgement or receives a negative acknowledgement or error signal.
